(19) United States
(12) Patent Application Publication
(10) Pub. No.: US 2026/0358841 A1
(43) Pub. Date: Nov. 12, 2026

(54) PRESSURE REGULATOR FOR GASEOUS FUEL, IN PARTICULAR HYDROGEN GAS

(71) Applicant: Poppe + Potthoff GmbH, Werther (DE)

(72) Inventors: Marcus JÜNTGEN, Falkensee (DE); Roger BUDDE, Callenberg (DE); Leonhard TRAPP, Berlin (DE); Andreas RINDT, Berlin (DE); Steven SCHULZ, Schwerin (DE); Philipp BREDENKAMP, Bielefeld (DE); Carsten SCHIPPERS, Eching (DE)

(21) Appl. No.: 19/475,429

(22) PCT Filed: Feb. 16, 2024
(86) PCT No.: PCT/EP2024/054014

§ 371 Date: Oct. 15, 2025

(30) Foreign Application Priority Data
Feb. 16, 2023 (EP) 23157106

(51) Int. Cl. G05D 16/20; F16K 17/02; F16K 17/40; F16K 49/00; G05D 7/06

(52) U.S. Cl. CPC G05D 16/2097; F16K 17/02; F16K 17/40; F16K 49/00; G05D 7/0635

(57) ABSTRACT

A pressure regulator for a gaseous fuel includes an inlet for the gaseous fuel at an inlet pressure, an outlet for the gaseous fuel, a main valve and an electronically controllable valve. The main valve comprises a main valve inlet, a main valve outlet, a main valve auxiliary inlet, and a control piston in a housing that controls fuel flow from the inlet through the main valve to the outlet. The electronically controllable valve is arranged to deliver the inlet pressure via the main valve auxiliary inlet to the regulating piston of the main valve as control pressure and thereby to control the fuel flow based at least on a pressure sensor signal indicating a pressure of the gaseous fuel at the outlet of the pressure regulator. The main valve further comprises a passage for the gaseous fuel arranged to relieve the control pressure acting on the control piston.

### CROSS REFERENCE TO RELATED APPLICATIONS

This application is a U.S. National Phase application under 35 U.S.C. § 371 of International Application No. PCT/EP2024/054014, filed on Feb. 16, 2024, and claims benefit to European Patent Application No. EP 23157106.8, filed on Feb. 16, 2023. The International Application was published in German on Aug. 22, 2024 as WO 2024/170750 A1 under PCT Article 21(2).

### FIELD

The invention relates to a pressure regulator for a gaseous fuel, in particular for hydrogen gas.

### BACKGROUND

Gaseous fuel, in particular hydrogen gas, as an energy carrier is stored in mobile applications in gaseous form in high-pressure containers or in liquid form in cooled low-pressure containers. Depending on the filling level of the storage containers, the pressure ratios decrease starting from the maximum filling level of the storage tank, and these decrease continuously as the gas is withdrawn, e.g. during driving. Tank pressures of 200, 350 or 700 bar at 100% tank filling are common today in the compressed gas storage sector. Tank pressures of less than 20 bar are used for cryogenic liquefied gas storage.

In order to be able to supply the stored fuel, e.g. hydrogen, to a consumer, the gas must be withdrawn from the storage tank at a variable pressure level of approx. 10 bar to 875 bar and conditioned to a pressure specific to the consumer. This conditioning is typically a depressurization that must be adapted to the respective consumer, e.g. a fuel cell or a hydrogen combustion engine. Fuel cells typically work with a hydrogen supply pressure of approx. 9 bar, hydrogen combustion engines with pressures of up to 60 bar. It is crucial here that the medium is made available to the consumer within a small pressure tolerance window, regardless of an often strongly fluctuating or decreasing gas mass flow, for example when the driver accelerates or brakes sharply. The fuel cell or combustion engine cannot achieve optimum efficiency due to a pressure drop in the supply line, particularly when the tank is empty or the gas mass flow is high at full load.

Pressure conditioning in the supply line is usually achieved or implemented using a mechanical pressure regulator. Such a mechanical pressure regulator reacts to the applied tank pressure by opening the spring-loaded valve with respect to the outflow side in the low-pressure range, which also exerts a force on the spring-loaded valve, by means of a fixed spring-area ratio. As long as these forces, generated by active surfaces of different sizes, are not balanced on the high-pressure and low-pressure sides, the valve is opened and gas flows from the high-pressure side to the low-pressure side, where the consumer is located and continuously draws off fuel/hydrogen. As the surfaces in these mechanical pressure regulators are not variable during operation, the falling pressure in the reservoir causes a proportional drop in pressure on the low-pressure side. This means that mechanical regulators without pressure equalization are often unable to achieve a control quality of more than 90%.

A pressure-balanced regulator has a special technical feature. Here, the problem of falling tank pressure is eliminated by the fact that the surface of the valve element facing the tank pressure is back-flushed by the low pressure. This type of mechanical pressure regulation is independent of the filling level of the storage tank, but is characterized by the fact that additional sealing elements between the high and low pressure areas of the regulator can have a negative effect on the service life and internal leakage of the regulator. Such regulators can achieve a control quality of 95%, but are often unreliable and therefore frequently fail prematurely.

Mechanical control valves are also characterized by the fact that it is not possible to directly influence the medium flowing to the consumer during operation. In addition, these regulators are often limited to low mass flow rates or fuel flows such as 3 g/s, which are common in the light vehicle sector (passenger cars). This limitation is due to the design-related force/area ratio of the control valve in combination with the preloaded spring element. For higher flow rates such as 7 g/s (light duty) or 16 g/s (heavy duty), very large surfaces and very strong spring elements would be necessary with regard to the pressure condition in the tank at 350 bar or 700 bar in order to be able to press the valves against the full tank pressure with a large valve cross-section, which increases the complexity, the manufacturing effort and therefore the costs.

Furthermore, there are control valves with electronic control that are designed in such a way that an inaccurate mechanical control is connected upstream in order to reduce the tank pressure to an intermediate pressure level that is acceptable for the electronic controller. The inlet pressure for the series-connected electronic regulator is subject to particularly large pressure fluctuations, which are dependent on the filling level of the storage container/tank. Due to the low inlet pressure, the electronic controller is able to carry out fine regulation for the consumer. A major disadvantage of this configuration is again a limited gas mass flow and a complex design. Outlet pressure changes, including mass flow changes, can only be made to a limited extent via the control unit, as the mechanical regulator is tank pressure-dependent and cannot be controlled separately. The use of such valves is therefore essentially limited to the natural gas sector with maximum tank pressures of 200 to 300 bar.

### SUMMARY

In an embodiment, the present disclosure provides a pressure regulator for a gaseous fuel including an inlet for the gaseous fuel at an inlet pressure, an outlet for the gaseous fuel, a main valve and an electronically controllable valve. The main valve comprises a main valve inlet, a main valve outlet, a main valve auxiliary inlet, and a control piston in a housing that controls fuel flow from the inlet through the main valve to the outlet. The electronically controllable valve is arranged to deliver the inlet pressure via the main valve auxiliary inlet to the regulating piston of the main valve as control pressure and thereby to control the fuel flow based at least on a pressure sensor signal indicating a pressure of the gaseous fuel at the outlet. The main valve further comprises a passage for the gaseous fuel arranged to relieve the control pressure acting on the control piston.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 shows a schematic representation of an embodiment of a pressure regulator;

FIG. 2a shows a schematic detailed view of the proportional valve of the embodiment of a pressure regulator from FIG. 1;

FIG. 2b shows a schematic detailed view of the main valve of the embodiment of a pressure regulator from FIG. 1;

FIG. 3 shows a schematic representation of a further embodiment of a pressure regulator according to the present disclosure;

FIG. 4 shows a schematic detailed view of the main valve of the embodiment of a pressure regulator from FIG. 3;

FIG. 5 shows a further schematic detailed view of the main valve of the embodiment of a pressure regulator from FIG. 3;

FIG. 6 shows a further schematic detailed view of the main valve of the embodiment of a pressure regulator from FIG. 3.

### DETAILED DESCRIPTION

As discussed above, the inventors have recognized that the pressure regulators known from the state of the art show deficits at high mass flow rates/fuel flows and/or with regard to their reliability. Furthermore, they can only react poorly to variability, such as strongly varying fuel consumption with fluctuating driving behavior. A problem addressed by the embodiments of the present disclosure is to at least partially reduce these and similar disadvantages of the prior art.

In this disclosure, unless otherwise stated, material properties are to be determined according to the relevant standards. Furthermore, in the following the term “substantially” is to be understood as “within typical design, measurement and/or manufacturing tolerances”.

An embodiment of the present disclosure relates to a pressure regulator for a gaseous fuel, in particular hydrogen gas, comprising an inlet for the gaseous fuel at an inlet pressure, an outlet for the gaseous fuel, a main valve comprising a main valve inlet, a main valve outlet, a main valve auxiliary inlet, and a control piston in a housing which regulates the fuel flow from the inlet through the main valve to the outlet, and an electronically controllable valve, in particular a proportional valve, which is set up to deliver inlet pressure via the main valve auxiliary inlet to the control piston of the main valve as control pressure and thereby regulate the fuel flow based at least on a pressure sensor signal, indicating the pressure of the gaseous fuel at the outlet of the pressure regulator, wherein the main valve further comprises a passage for the gaseous fuel adapted to relieve the control pressure acting on the control piston and preferably arranged in the control piston and/or the housing.

For example, the passage can be arranged in the base of the control piston, in the circumference of the control piston and/or as a bypass in a guide ring system. Such a passage integrated in or on the control piston improves the response behavior of the control piston to changes in the control pressure without complicating the design of the pressure regulator. A further advantage of this arrangement is that the mechanical design of the control piston has a significant influence on the dynamic response behavior of the pressure regulator. This allows pressure regulators to be adapted to different requirements by installing control pistons with different passages.

Alternatively or additionally, the passage can also be implemented via a non-return valve integrated into the control piston, via a filter, a gap between the control piston and the housing wall and/or via one or more channels in the wall of the control piston or in the housing wall, and/or via a flow pad as a result of a surface roughness of the wall of the control piston and/or the housing wall.

The pressure regulator described herein can thus operate essentially independently of the inlet pressure, which is not the case with mechanical regulators or mechanical control stages, for example. Furthermore, the pressure regulator can be controlled and configured via an engine control unit in order to regulate the pressure and the mass flow or the fuel flow according to customizable set values for the pressure and the mass flow.

During operation, increased fuel consumption by the consumer (e.g. a fuel cell) leads to a pressure drop at the outlet of the pressure regulator, which is indicated by the pressure sensor signal and causes the electronically controllable valve to open. This controls the control piston to increase the flow through the main valve until the outlet pressure corresponds to the set value again. Accordingly, lower fuel consumption leads to an increase in pressure at the outlet and thus to the closing of the electronically controllable valve. In this case, the passage of the control piston means that the control piston can react as quickly as possible to the reduced pressure control signal, thereby improving the response behavior, bandwidth and step response of the control circuit.

The pressure regulator described herein also has a particularly fast response behavior in the event of a load change. This property is achieved, among other things, by the design of the control piston described here. The control piston is preferably located in a cylinder guide with a minimum volume above the piston, whereby activation in the form of gas addition by the electronically controllable valve results directly in a change in the position of the piston. If the flow through the electronically controllable control valve (preferably designed as an electromagnetic proportional valve) is reduced, the control pressure can be quickly reduced again via the passage of the control piston.

The pressure regulator described here can provide high mass or fuel flows with simultaneously highly variable pressure ranges and keep the output pressure constant with high accuracy with highly varying mass or fuel flows. In contrast to previously known pressure regulators, it is not limited to mass flow rates of 3 g/s. Its capacity is above 10 g/s, depending on the residual filling pressure of the tank. At residual filling pressures of 30 bar or more, mass flow rates of up to 20 g/s are possible without having to make any design changes to the existing assembly. The pressure regulator described here has a single-stage design and can therefore dispense with an upstream mechanical pressure control valve.

The pressure regulator described here can use the pressure of the pressurized gaseous fuel by dosing the tank pressure via the electronically controllable valve as control pressure to the control piston of the main valve. This type of pneumatic valve control ensures particularly precise control of the output pressure signal. In real gas tests, a control quality of over 99% was achieved by the pressure regulator described here at inlet pressures of up to 860 bar and usual outlet pressures between 9 bar and 40 bar. At very low outlet pressures of less than 3 bar, control qualities of approx. 90-95% were achieved. The pressure regulator described here can operate with variable output pressure levels from 1 bar to 60 bar.

A further advantage of the pressure regulator described herein is that it can be designed in such a way that, depending on the application, it can be adapted to the general conditions, such as material and/or installation space requirements, and additional components can be integrated, e.g. as described herein, without having to replace an unnecessarily large number of components or change the basic design of the pressure regulator. Such adaptations to the respective conditions make it possible to achieve control qualities of over 99% even at very low output pressures or mass flows. The design of the control piston and the passage also means that the pressure regulator can react very quickly to changing pressure and flow requirements. This increases the control bandwidth, which improves the control quality, reduces pressure oscillations and improves the step response behavior of the regulator or the control circuit, e.g. in the case of strong and instantaneous load requirements.

The pressure regulator described here can also be installed in any position; in particular, it can be used in parallel for stationary or mobile applications with particularly high consumption throughputs without negatively influencing the other regulators or the output pressure signal. The pressure regulator can be used for compressed gas storage systems, liquid gas storage systems and all other types of hydrogen or alternative gas treatment. The regulator is a very robust solution across all areas of application, meaning that regular maintenance of the pressure regulator is not necessary.

In order to minimize the response time of the control piston to a change in the control pressure and thus increase the control bandwidth of the control circuit, the volume between a surface of the control piston on which the control pressure acts and a housing in which the control piston moves, in the closed state, can be in a range from 100 mm³ to 1000 mm³, preferably in a range between 300 mm³ and 700 mm³. Alternatively or additionally, a volume of a connecting bore from the outlet of the electronically controllable valve to the auxiliary inlet of the main valve can be in the range between 40 mm³ and 500 mm³, preferably in the range between 100 mm³ and 250 mm³. Alternatively or additionally, an outlet volume of the electronically controllable valve may be in the range between 400 mm³ and 1200 mm³, preferably in the range between 650 mm³ and 950 mm³.

Furthermore, the pressure regulator can be designed such that a diameter of a surface of the control piston exposed to the control pressure is in the range of 30 mm to 50 mm. This relatively large surface enables precise regulation of the pressure. The shut-off body of the main valve can have a diameter of 2 mm to 6 mm, for example. The resulting surface ratio, i.e. between the control piston and the shut-off body, further improves the control quality. Embodiments of the pressure regulator described here include pressure regulators with non-circular control piston and/or shut-off body cross-sections. Their cross-sections have area sizes comparable to those described herein in relation to exemplary cylindrical control pistons and shut-off bodies with circular cross-sections.

The pressure regulator can also be designed such that the passage comprises a throttling element that influences how the control pressure is reduced, whereby the throttling element can preferably be adjustable and can thus, for example, change the effective line cross-section of the passage. This makes it possible to precisely match the response behavior of the control piston to the intended use of the pressure regulator.

The main valve of the pressure regulator can, for example, be set up to adjust a variable fuel flow rate in the range from 0.02 g/s to 50 g/s. A variable fuel flow rate allows the regulator to be operated depending on the situation and adapted to the possibly strongly fluctuating requirements of a downstream fuel-consuming element, e.g. a fuel cell, a gas turbine or an internal combustion engine.

In an exemplary embodiment, the pressure regulator may further comprise a device for temperature control by means of heating and/or cooling. Such a temperature control represents an advantageous additional safety mechanism. Particularly when working with gaseous fuels, unwanted temperature changes can occur, which can be prevented and/or counteracted with an appropriate temperature control device. Keeping the temperature as constant as possible reduces mechanical expansion/contraction of the pressure regulator components and leads to improved operational stability of the regulator.

For example, two components can be cooled and/or heated: firstly, the pressure regulator itself in order to ensure functionality at low media temperatures at the inlet or low/high ambient temperatures due to engine heat or atmospheric conditions and secondly, the escaping gas at the outlet for preconditioning in order to ensure the highest possible effectiveness/efficiency of the energy generator.

For example, the pressure regulator can be set up so that the temperature control device includes cooling channels in the area of a main valve body of the main valve for liquid-based cooling of the main valve and/or an electric heater for heating the main valve.

The optional temperature control of the pressure regulator made possible by this can, for example, take place via an attached flange, which optionally also represents the cover of the main valve housing. This cover can, for example, either be electrically heated or conditioned via cooling fins and fluid channels connected to the cooling circuit of the vehicle/unit. Temperature conditioning as described above can be implemented in a special type of housing design directly via cooling fins and cooling channels in the housing area, similar to the design of a liquid-cooled cylinder head in the area of an internal combustion engine.

An exemplary embodiment of the pressure regulator may further comprise a control unit that controls the electronically controllable valve at least partially based on the at least one pressure sensor signal, preferably using pulse width modulation (PWM). A PWM signal generated by the control unit can be used, for example, to adjust the stroke of the valve. Preferably, a proportional valve is used and the frequency of the PWM is high enough (e.g. >300 Hz or >1 kHz) for the proportional valve to act as a low-pass filter for the PWM signal. This prevents the PWM signal from causing fluctuations in the pressure control signal acting on the control piston. The use of a proportional valve has the additional advantage that the shut-off body of the proportional valve only rarely touches the sealing seat during operation, thereby significantly reducing wear-for example in comparison to an electronically controllable shut-off valve. In addition to the at least one pressure sensor signal that indicates the outlet pressure, the pressure regulator can also take into account other signals such as an inlet pressure signal. Furthermore, the control unit can adjust its control parameters (e.g. control gain, type of control, etc.) based on a signal indicating the mass or fuel flow requested by a consumer.

Such a control unit makes it possible to operate the pressure regulator adapted to special operating conditions (e.g. full load when operating a hydrogen combustion engine): For example, more fuel can be supplied to the engine for a short time by increasing the pressure in the low-pressure range upstream of the injection nozzle. For an exemplary range extender programming, a gradation of the maximum available withdrawal quantity is possible. The pressure regulator can also be electronically pilot-controlled in the event of a load change, e.g. to close the main valve prematurely and thus save fuel.

The pressure regulator can also include at least one temperature sensor for detecting the temperature of the gaseous fuel in the pressure regulator. A corresponding temperature measurement is particularly advantageous in combination with the devices for temperature control by means of heating and/or cooling. Alternatively or additionally, such temperature detection represents an advantageous safety mechanism, for example in order to be able to issue a warning signal and/or otherwise react in the event of overheating or an unintentional drop in temperature.

In a further example, the electronically controllable valve of the pressure regulator can have a maximum stroke of up to 15 mm, preferably up to 10 mm, even more preferably up to 5 mm. This allows a controlled gas supply to be achieved without pulsation disturbances in the control line.

For example, the electronically controllable valve can be set up to absorb pressures of up to 1500 bar, up to 1200 bar, up to 1000 bar or up to 700 bar in the proportional valve housing itself. The electronically controllable valve can thus be able to withstand corresponding internal pressures without bursting and the inlet pressure can be delivered directly via the electronically controllable valve as control pressure to the control piston.

The pressure regulator may further comprise one or more of the following components: a relief valve arranged in the flow path downstream of the main valve and opening at a pressure greater than the controllable outlet pressure of the pressure regulator, preferably at a pressure of over 30 bar or over 70 bar, a Service Interface Unit, SIU, arranged in the flow path downstream of the main valve, and an electronically controllable vent valve arranged in the flow path downstream of the main valve. In this way, the pressure regulator can also be vented automatically and it is ensured that, in the event of a fault, the outlet pressure does not become so high that it can damage downstream assemblies, such as a fuel cell. To further improve the safety of the pressure regulator, all valves of the pressure regulator can be in an NC configuration (NC: normally closed).

In order to improve the control accuracy or quality and the functional integration and/or to enable on-line diagnostics, the pressure regulator can also comprise one or more of the following components: a pressure sensor for measuring a pressure of the gaseous fuel at the outlet, which provides the pressure sensor signal, a pressure sensor for measuring the pressure of the gaseous fuel at the inlet, which provides a further pressure sensor signal that can be used to regulate the fuel flow; and/or a further pressure sensor for measuring a pressure of the gaseous fuel at the outlet, which provides a further pressure sensor signal for signal redundancy.

In the following, an exemplary embodiment of the present disclosure is described. Various combinations of features are described with reference to the embodiments shown. Naturally, not all features of the described embodiments need to be present in order to realize the present invention. Furthermore, the embodiments may be modified by combining certain features of one embodiment with one or more features of another embodiment-if technically compatible and useful-without departing from the disclosure and the scope of protection of the present invention as defined by the patent claims. Some features, functions and properties of the pressure regulator, which have already been described in general terms in section 3, are only briefly mentioned below or not described at all in order to avoid repetition.

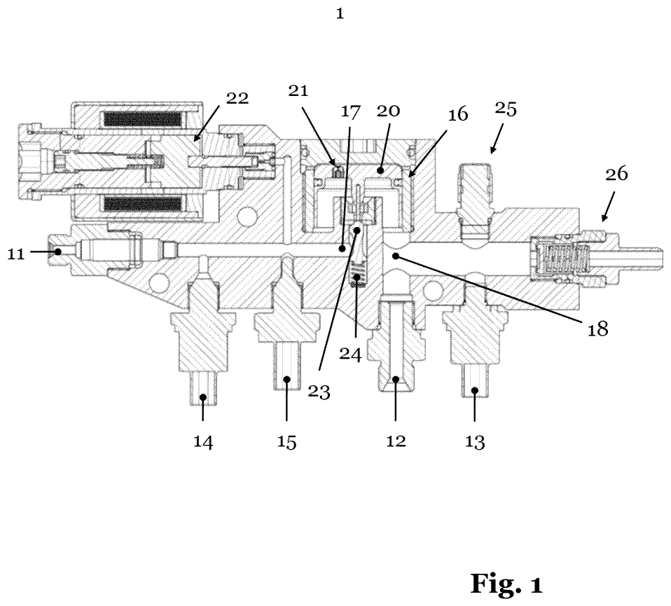

FIG. 1 shows a schematic representation of an embodiment of a pressure regulator 1 comprising an inlet 11, an outlet 12, a pressure sensor 14 for measuring the pressure of the gaseous fuel at the outlet 12, a pressure sensor 13 for measuring the pressure of the gaseous fuel at the inlet 11, and a temperature sensor 15, each of which is attached to the main body of the pressure regulator 1. Embodiments without some or all of the sensors shown are also possible. For example, the outlet pressure can also be measured at the inlet of a downstream consumer or in a manifold assembly.

The inlet 11 and the outlet 12 are connected to a main valve 16 by a line through the main body of the pressure regulator 1. The main valve 16 comprises a main valve inlet 17, a main valve outlet 18, a main valve auxiliary inlet (not in the sectional plane), and a control piston 20 movable in the main valve 16 for regulating the fuel flow through the main valve 16.

In a closed position, the control piston 20 blocks a path between main valve inlet 17 and main valve outlet 18 so that no gas can flow from main valve inlet 17 to main valve outlet 18. In an open position, the control piston 20 clears a path between main valve inlet 17 and main valve outlet 18 so that gas can flow from main valve inlet 17 to main valve outlet 18.

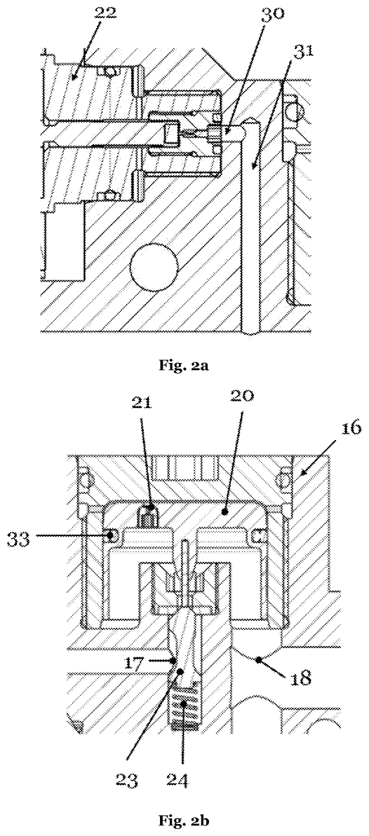

The control piston 20 controls the fuel flow by moving a shut-off body 23 against the spring 24. The shut-off body 23 thereby releases from the sealing seat of the main valve 16 and opens up a flow path from the main valve inlet 17 to the main valve outlet 18. During operation, the shut-off body 23 is not only pressed against the sealing seat of the main valve by the spring 24, but also by the pressure of the fuel at the inlet 17. The further the control piston 20 is displaced in the direction of the spring 24, the larger the effective flow cross-section through the main valve becomes. As a result, the main valve 16 is set up to control the gas flow between inlet 11 and outlet 12 of the pressure regulator 1. The pressure regulator 1 shown also comprises an electromagnetic proportional valve 22, which is set up to deliver the inlet pressure via the main valve auxiliary inlet to the control piston 20 of the main valve 16 as control pressure (see also FIG. 2a).

The control piston 20 also comprises a passage 21 (in the embodiment shown, comprising an adjustable throttling element) for the gaseous fuel, which is set up to reduce the control pressure acting on the control piston 20 so that it can move back into the closed position when the control pressure is reduced. This is shown in detail in FIG. 2b. A stronger electrical current flow through the solenoid coils of the proportional valve 22 results in a greater control pressure acting on the control piston 20, which thereby increases the flow through the main valve. Advantageous dimensions of the control piston 20 and the shut-off body 23 as well as further possibilities for implementing the flow rate are described in section 3.

The pressure regulator 1 may further comprise (or be connected to) a control unit that controls the proportional valve 22 based, at least in part, on a pressure sensor signal generated by the pressure sensor 14 in the outlet region of the pressure regulator. The control unit compares the pressure sensor signal with a target value for the outlet pressure and, in the event of a deviation from the target value, changes the current flow through the solenoid coils of the proportional valve 22 in order to increase or reduce the control pressure on the control piston 22. This also increases or reduces the fuel flow through the main valve 16 in order to reduce the deviation from the setpoint. During operation and when the control circuit is closed, for example, increased fuel consumption by a consumer leads to a lower pressure in the outlet area 18.

The proportional valve 22 is controlled via pulse width modulation (PWM), for example. The stroke of the proportional valve 22 and thus the control pressure on the control piston 22 can be adjusted via the pulse width of the PWM signal generated by the control unit. A change in the pulse width of the PWM signal causes the shut-off body of the proportional valve 22 to be moved towards or away from the sealing seat. In this way, the adjustable control pressure can be applied to the control piston. Preferably, the frequency of the PWM signal is high enough (e.g. >300 Hz or >1 kHz) for the proportional valve 22 to act as a low-pass filter for the PWM signal. This can prevent the PWM signal from causing fluctuations in the control pressure acting on the control piston 20.

The use of a proportional valve 22 has the additional advantage that the shut-off body of the proportional valve 22 only rarely touches the sealing seat during operation, thereby significantly reducing wear-for example, compared to an electronically controllable shut-off valve that is either closed or open. In addition to the signal from the pressure sensor 14, the pressure regulator 1 can also take into account other signals such as an inlet pressure signal from the sensor 13. Furthermore, the control unit can adjust its control parameters and thus the transfer function based on a signal that indicates the mass or fuel flow requested by a consumer.

The pressure regulator 1 can also include a pressure relief valve 26 on the outlet side, the release pressure of which can be adjusted according to the area of application of the pressure regulator 1. The pressure regulator 1 can also comprise a Service Interface Unit (SIU) 25. In the embodiment shown in FIG. 1, the SIU 25 is provided with a removable cap. After removing the cap, a standard hose can be attached to the SIU 25, e.g. with a thread. The standard hose can have a centrally and axially positioned mandrel, which is set up to move a spring-loaded sealing element of the SIU 25 from its home position, so that gas from the outlet area of the pressure regulator can be discharged through the hose in a controlled manner.

The pressure regulator 1 can also include an active purge valve. The active purge valve can be arranged alternatively to the SIU 25 at its position. The active purge valve can, for example, be activated electromagnetically and can, for example, be opened for a short period of time, e.g. a few seconds, after an engine connected to the pressure regulator 1 has stopped, in order to drain any remaining fuel from the pressure regulator 1. By integrating the SIU 25 and/or the purge valve, the pressure regulator 1 enables targeted ventilation of the low-and high-pressure areas for servicing. The pressure regulator 1 can thus be equipped with a shut-off mechanism.

By integrating the SIU 25, pressure regulator 1 also enables targeted pressure reduction in the low-pressure line between pressure regulator 1 and the consumer after the system has been switched off, as well as controlled pressure reduction during longer downtimes.

The exemplary pressure regulator 1 is designed in such a way that all integrated valves are in an NC configuration (normally closed), which leads to increased safety in the event of damage. The function and use of the temperature sensor 15 is described in more detail in section 3.

FIG. 2a shows a schematic detailed view of the proportional valve 22 of the embodiment of a pressure regulator 1 in FIG. 1. The proportional valve inlet 30 is connected to the inlet 11 of the pressure regulator 1 via a vertical supply line 31. As described above in section 3 and in FIG. 1, the proportional valve 22 is set up to conduct the pressure present at the inlet 30 via a line in the main body of the pressure regulator 1 (not in the sectional plane) as control pressure to the upper side of the control piston 20 of the main valve 16.

FIG. 2b shows a schematic detailed view of the main valve 16 of the pressure regulator 1 of FIG. 1. In FIG. 2b it can be seen in particular that the passage 21 is arranged with a throttling element in the piston head of the control piston 20, via which the flow cross-section of the passage 21 can be adjusted. Other embodiments of the passage 21 of the control piston 20 are described above in section 3. For example, the passage 21 could also be integrated in the guide ring system 33 of the control piston 20, or the control piston 20 can have elongated channels on its outer wall or the housing wall can have elongated channels. FIG. 2b also shows the shut-off body 23 in the closed position and the spring 24. Since the surface area of the control piston 20 is significantly larger than the surface area of the shut-off body 23, as described in more detail in section 3, the control pressure can be significantly lower than the inlet pressure that presses the shut-off body 23 against the sealing seat of the main valve 16. In particular, the diameter of the surface of the control piston 20 exposed to the control pressure may be in the range of 30 mm to 50 mm and/or the effective diameter of the surface of a shut-off body 23 of the main valve 16 exposed to the inlet pressure may be in the range of 1 mm to 10 mm, preferably in the range of 2 mm to 6 mm. The volume between the surface of the control piston 20 on which the control pressure acts and the housing in which the control piston 20 moves may be in the range of 100 mm³ to 1000 mm³ when closed, and preferably in the range of 300 mm³ to 700 mm³.

Essential aspects of the mode of operation of some embodiments of the pressure regulator 1 described here can also be characterized as follows using similar terms:

Pressure regulator 1 with an inlet 11 and an outlet 12, between which a first flow path and a second flow path are arranged, a shut-off body 23 for opening and closing the first flow path and a controllable valve device 22 for opening and closing the second flow path, a control piston 20 with an operating direction from the outlet 12 to the inlet 11 to move the shut-off body 23 from a closed position to an open position in which the first flow path is open and a closing spring 24 with an operating direction from the inlet 11 to the outlet 12 to move the shut-off body 23 from an open position to a closed position, in which the first flow path is closed, with control piston 20 connecting the first and second flow paths and the control piston 20 generating a pressure drop between the valve device and the outlet of the pressurized side of the control piston 20 when the second flow path is open, in order to move the shut-off body 23 by the control piston against the force of the closing spring 24 and against the pressure in the outlet from the closed position to the open position.

The control piston 20 described here thus functions as a control means which transfers the differential pressure force from the control pressure and the outlet pressure to the shut-off body 23, thereby opening the main valve 16. Other control means, such as a diaphragm with a passage, are also possible. Furthermore, the passage described here functions as a throttling element, which enables a pressure difference between the control pressure and the outlet pressure. Other throttling elements, such as a porous material of the control piston, are also conceivable.

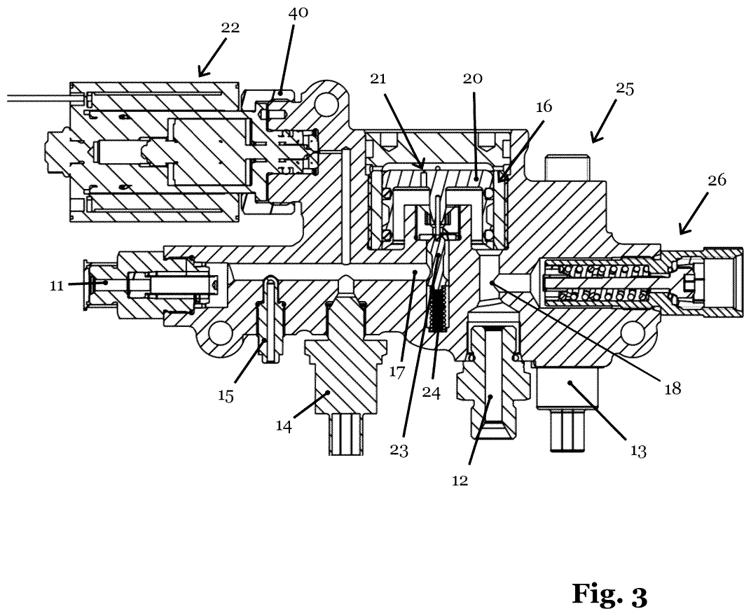

FIG. 3 shows a further embodiment of a pressure regulator 1 according to the present disclosure. In the following, only significant design differences to the embodiments described above are described. In particular, the pressure regulator 1 illustrated in FIG. 3 has a further development of the electronically controllable valve 22. In particular, the electronically controllable valve 22 can be connected to a housing of the pressure regulator 1 by means of a union nut 40 in such a way that, when the union nut 40 is fixed to the housing, a sealing needle of the electronically controllable valve 22 can be moved towards an associated sealing seat of the housing essentially without torsion. Such a design reduces the likelihood of damage and/or leakage during assembly, maintenance and/or operation.

It has been shown that it can be advantageous for tightness to manufacture the sealing needle of the electronically controllable valve 22 from a metal, preferably from a copper-based alloy such as brass or bronze, and the associated sealing seat of the housing from a polyamide-based polymer, preferably from Vespel. The sealing needle can also be manufactured in one piece with a valve piston of the electronically controllable valve 22. The valve piston of the electronically controllable valve 22 can also be mounted on two sides, whereby the bearings of the valve piston are arranged in such a way that the gaseous fuel does not flow against them. Such an arrangement improves the operation of the electronically controllable valve 22. In particular, vibrations of the valve piston can be reduced and the control quality improved.

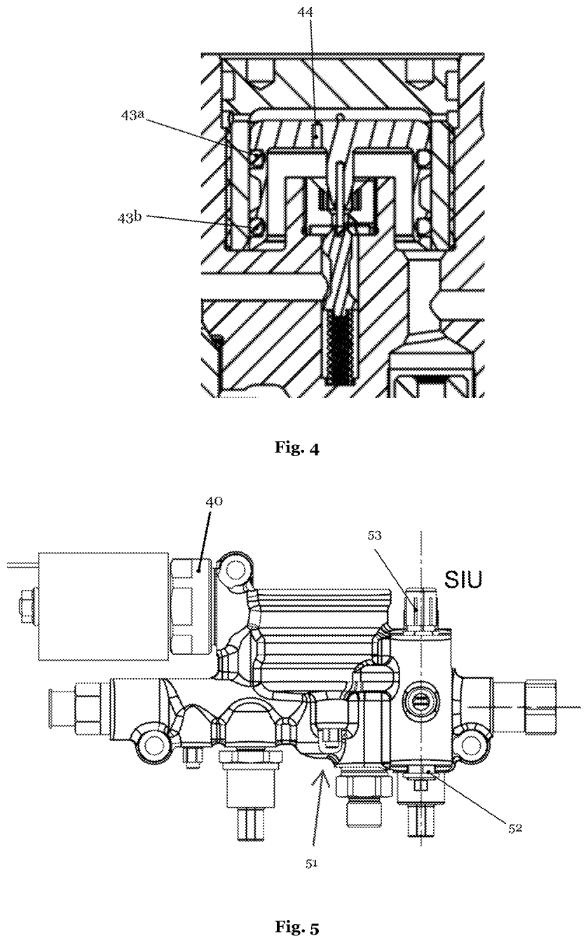

The control piston 20 of the main valve 16 of the pressure regulator 1 can furthermore, as shown in FIG. 4, be movably mounted in the housing via two bearing elements 43a, 43b, and preferably be made of a metal, preferably a copper-based alloy such as brass or bronze. Alternatively or additionally, the control piston 20 of the main valve 16 may have a spring-biased piston ring. For example, such bearing elements provide an additional sealing and damping function for the control piston 20.

In other implementations, the control piston 20 of the main valve 16 can also be made of a polymer with suitable frictional properties, such as PTFE, and have integrated plain bearings. These design enhancements of the control piston improve the vibration properties of the control piston 20 during operation, particularly in the case of large pressure differences and mass flows.

Furthermore, the pressure regulator 1 can have a temperature sensor 51 for measuring the temperature of the gaseous fuel as it flows towards the control piston 20. It has been shown that this measurement can be used to improve the control quality of the pressure regulator.

Furthermore, it has been shown that it is advantageous for safety during operation to design the pressure relief valve 26 in such a way that, when open, it has an effective flow cross-section that is greater than a sum of an effective flow cross-section of the main valve 16 and an effective flow cross-section of the passage 21. This ensures that, in the event of a fault, strong overpressures cannot occur in the pressure regulator.

To further improve safety, a rupture disk can be arranged in the medium pressure range downstream of the main valve, e.g. in a further interface, and bursts at a pressure that is significantly greater than the normal system pressure during operation, e.g. >100 bar. Alternatively or additionally, a further pressure relief valve can be provided as an alternative/further safeguard, which has a higher opening pressure than the first pressure relief valve 26 and opens additionally if the pressure rises further.

In order to improve the maintenance properties of the pressure regulator, the pressure regulator can have a manual valve 52 with which the SIU 53 can be closed and opened. The manual valve 52 can make it possible to keep the SIU 53 depressurized during operation, e.g. in order to take the load off this component and additionally reduce the risk that a quick coupling can be connected under applied high pressure.

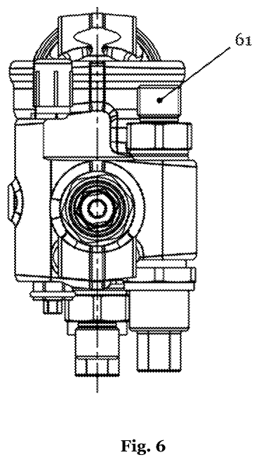

For applications with several consumers, e.g. in trucks with several fuel cells, it can be useful, as shown in FIG. 6, to provide a second outlet 61 for the gaseous fuel, which is in fluid connection with the first outlet 12. This allows several consumption paths to be served with one pressure regulator. Another application is hydrogen combustion engines, which often require an additional connection due to their design (e.g. V-engines).

In order to further improve the safety of the pressure regulator 1 during operation and also to prevent damage to the pressure regulator 1 and/or other components that are in fluid connection with the pressure regulator in the event of unusual faults, a multi-stage safety system was developed for the pressure regulator 1, which has the following interacting components: a pressure relief valve 26 as described above, a rupture disk or an additional pressure relief valve as described above, and a control unit, which is set up to trigger an emergency shutdown of the electronically controllable valve 22, e.g. by resonantly short-circuiting solenoid coils of the electronically controllable valve 22 via a diode.

The control unit can also be set up to detect a fault in the pressure regulator 1 based on one or more sensor signals and, in response, to trigger the emergency shutdown of the electronically controllable valve 22. Preferably, the control unit can be integrated into or is implemented in an engine control unit/main control unit of the system/vehicle. This allows the pressure regulator 1 with its entire sensor system to be controlled together with other valves of the system (e.g. solenoid valves of OTVs, etc.), e.g. in order to be able to interrupt the supply line to the pressure regulator 1 immediately in the event of a fault.

For example, the one or more sensor signals may include one or more of the following: a sensor signal from one or more temperature sensors 15 for the gaseous fuel; a sensor signal from the pressure sensor 14 and/or the pressure sensor 13 and/or a difference thereof (i.e., a pressure difference before and after the main valve 16), a sensor signal from a mass flow sensor arranged in the flow path after the outlet 12, which preferably measures a mass flow of the gaseous fuel at the inlet of a fuel cell or an internal combustion engine.

In this way, typical faults can be reliably prevented and the probability of system failure or serious damage can be greatly reduced.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

1. A pressure regulator for a gaseous fuel, the pressure regulator comprising:
an inlet for the gaseous fuel at an inlet pressure;
an outlet for the gaseous fuel;
a main valve comprising a main valve inlet, a main valve outlet, a main valve auxiliary inlet, and a control piston in a housing that controls fuel flow from the inlet through the main valve to the outlet; and
an electronically controllable valve, which is arranged to deliver the inlet pressure via the main valve auxiliary inlet to the regulating piston of the main valve as control pressure and thereby to control the fuel flow based at least on a pressure sensor signal indicating a pressure of the gaseous fuel at the outlet,
wherein the main valve further comprises a passage for the gaseous fuel arranged to relieve the control pressure acting on the control piston.

2. The pressure regulator according to claim 1, wherein:
a volume between a surface of the control piston on which the control pressure acts and a housing in which the control piston moves, in a closed state, is in a range from 100 mm³ to 1000 mm³; and/or
a volume of a connecting bore from the outlet of the electronically controllable valve to the auxiliary inlet of the main valve is in a range between 40 mm³ and 500 mm³; and/or
an output volume of the electronically controllable valve is in a range between 400 mm³ and 1200 mm³.

3. The pressure regulator according to claim 1, wherein:
a diameter of a surface of the control piston exposed to the control pressure is in a range of 30 mm to 50 mm; and/or
a diameter of a surface of a shut-off body of the main valve exposed to the inlet pressure is in a range of 1 mm to 10 mm.

4. The pressure regulator according to claim 1, wherein:
the passage is arranged in a control piston base, in a circumference of the control piston and/or as a bypass in a guide ring system of the control piston; and/or
the passage is connected via a check valve integrated in the control piston, via a filter, a gap between the control piston and the housing wall, via one or more channels in the wall of the control piston or in the housing wall, and/or via a flow pad as a result of a surface roughness of the a of the control piston and/or a wall of the housing.

5. The pressure regulator according to claim 1, wherein the passage comprises a throttling element that is configured to influence how the control pressure is relieved.

6. The pressure regulator according to claim 1, wherein the main valve is adapted to adjust a variable fuel flow rate in a range of 0.02 g/s to 50 g/s, and wherein the pressure at the outlet is adjustable in a range between 1 bar and 60 bar.

7. The pressure regulator according to claim 1, further comprising a temperature control device configured to control temperature by heating and/or cooling.

8. The pressure regulator according to claim 7, wherein the temperature control device comprises cooling channels in a region of a main valve body of the main valve for liquid-based cooling of the main valve and/or an electric heater for heating the main valve.

9. The pressure regulator according to claim 1, further comprising a controller configured to control the electronically controllable valve, at least partly based on the at least one pressure sensor signal.

10. The pressure regulator according to claim 1, further comprising at least one temperature sensor arranged to detect a temperature of the gaseous fuel in the pressure regulator.

11. The pressure regulator according to claim 1, wherein the electronically controllable valve has a maximum stroke of up to 15 mm.

12. The pressure regulator according to claim 1, wherein the electronically controllable valve is adapted to receive pressures of up to 1500 bar in a housing of the electronically controllable valve.

13. The pressure regulator according to claim 1, further comprising:
a relief valve arranged in the flow path downstream of the main valve and opening at a pressure greater than a controllable outlet pressure of the pressure regulator; and/or
a Service Interface Unit (SIU) arranged in the flow path downstream of the main valve; and/or
an electronically controllable vent valve arranged in the flow path downstream of the main valve; and/or
a manual valve with which the SIU is closable and openable.

14. The pressure regulator according to claim 1, further comprising:
a pressure sensor configured to measure the pressure of the gaseous fuel at the outlet, providing the pressure sensor signal; and/or
a pressure sensor configured to measure the inlet pressure of the gaseous fuel at the inlet, which provides a further pressure sensor signal that is useable to control the fuel flow; and/or
a further pressure sensor configured to measure the pressure of the gaseous fuel at the outlet, which provides a further pressure sensor signal for signal redundancy.

15. The pressure regulator according to claim 1, wherein all valves of the pressure regulator are in a normally closed (NC) configuration.

16. The pressure regulator according to claim 1, wherein:
the electronically controllable valve is connectable to a housing of the pressure regulator with a union nut in such a way that when the union nut is fixed to the housing, a sealing needle of the electronically controllable valve is movable essentially torsion-free towards an associated sealing seat of the housing; and/or
the sealing needle is made of a metal, and the associated sealing seat of the housing is made of a polyamide-based polymer; and/or
the sealing needle is made in one piece with a valve piston of the electronically controllable valve; and/or
the valve piston of the electronically controllable valve is mounted on two sides, the bearings of the valve piston being arranged in such a way that they are not exposed to the flow of the gaseous fuel.

17. The pressure regulator according to claim 1, wherein:
the control piston of the main valve is movably mounted in the housing via two bearing elements; and/or
the control piston of the main valve has a spring-biased piston ring; and/or
the control piston of the main valve is made of a polymer and has integrated plain bearings which provide a sealing and damping function.

18. The pressure regulator according to claim 10, wherein the at least one temperature sensor comprises a temperature sensor configured to measure a temperature of the gaseous fuel flowing towards the control piston of the main valve.

19. The pressure regulator according to claim 13, wherein the pressure relief valve has an effective flow cross-section in an open state that is larger than a sum of an effective flow cross-section of the main valve and an effective flow cross-section of the passage.

20. The pressure regulator according to claim 1, further comprising:
a rupture disk that is in fluid connection with the flow path downstream of the main valve and bursts at a pressure of >100 bar; and/or
a further relief valve that has a greater opening pressure than the relief valve.

21. The pressure regulator according to claim 1, further comprising:
a second outlet for the gaseous fuel, which is in fluid connection with the outlet.

22. A multi-stage safety system for the pressure regulator according to claim 1, the multi-stage safety system comprising:
a pressure relief valve; and
a control unit adapted to trigger an emergency shutdown of the electronically controllable valve.

23. The safety system according to claim 22, wherein the control unit is set up to detect a fault of the pressure regulator based on one or more sensor signals and, in response thereto, to trigger the emergency shutdown of the electronically controllable valve.

24. The safety system according to claim 23, wherein the one or more sensor signals comprise one or more of the following:
a sensor signal of one or more temperature sensors for the gaseous fuel;
a sensor signal of the pressure sensor and/or the pressure sensor and/or a difference thereof;
a sensor signal of a mass flow sensor arranged in the flow path downstream of the outlet.
